(19) United States
(12) Patent Application Publication
(10) Pub. No.: US 2026/0219075 A1
(43) Pub. Date: Jul. 30, 2026

(54) SENSOR SYSTEM FOR A HIGH PRECISION GIMBAL INDICATOR

(71) Applicant: Raytheon Company, Arlington, VA (US)

(72) Inventor: Michael K. Burkland, Tucson, AZ (US)

(21) Appl. No.: 19/041,696

(22) Filed: Jan. 30, 2025

(51) Int. Cl. G01D 5/30; F41G 7/22

(52) U.S. Cl. CPC G01D 5/305; F41G 7/2213; G01D 2205/26; G01D 2205/95

(57) ABSTRACT

A sensor system includes a seeker ball and a plurality of targets including variable pitch diffraction gratings disposed at different positions on a surface of the seeker ball relative to each other. The sensor system also includes a plurality of cylindrically-symmetric high precision gimbal indicator (HPGI) sensors, each HPGI sensor including a corresponding stop radially aligned with a center of the seeker ball and configured to track a position of a corresponding target of the plurality of targets. In addition, the sensor system includes a controller configured to receive outputs from the HPGI sensors and determine, based on the outputs, an instantaneous and absolute angular position of the seeker ball.

### TECHNICAL FIELD

This disclosure generally relates to sensor systems. More specifically, this disclosure relates to a sensor system for a high precision gimbal indicator (HPGI), such as one that can decouple sensing of an angular state of a ball with a socket (like a ball joint gimbal) to each orthogonal rotational axis.

### BACKGROUND

Gimbaled system hardware for missile seekers and similar devices have been developed with an eye toward size and weight reductions for small-diameter airframes. This has led to a ball joint gimbal (BJG) design in which a seeker ball is controlled by a piezoelectric ultrasonic motor system. To properly control such a BJG, an absolute position encoder system may be used to track the angular position of the seeker ball. However, existing absolute position encoder systems are typically unable to properly track the angular orientation of a seeker ball when moving in three axes of angular rotation.

### SUMMARY

This disclosure relates to a sensor system for a high precision gimbal indicator.

In some examples, a sensor system may include a seeker ball and a plurality of targets including variable pitch diffraction gratings disposed at different positions on a surface of the seeker ball relative to each other. The sensor system may also include a plurality of cylindrically-symmetric high precision gimbal indicator (HPGI) sensors, each HPGI sensor including a corresponding stop radially aligned with a center of the seeker ball and configured to track a position of a corresponding target of the plurality of targets. In addition, the sensor system may include a controller configured to receive outputs from the HPGI sensors and determine, based on the outputs, an instantaneous and absolute angular position of the seeker ball.

In other examples, a method of operating a sensor system may include receiving outputs from a plurality of cylindrically-symmetric HPGI sensors. The method may also include determining, based on the outputs, an instantaneous and absolute angular position of a seeker ball of the sensor system. The seeker ball may include a plurality of targets including variable pitch diffraction gratings disposed at different positions on a surface of the seeker ball relative to each other. Each HPGI sensor may include a corresponding stop radially aligned with a center of the seeker ball and configured to track a position of a corresponding target of the plurality of targets.

In still other examples, a non-transitory machine readable medium may contain instructions that, when executed by at least one processor, cause the at least one processor to receive outputs from a plurality of cylindrically-symmetric HPGI sensors. The non-transitory machine readable medium may also contain instructions that, when executed by the at least one processor, cause the at least one processor to determine, based on the outputs, an instantaneous and absolute angular position of a seeker ball of a sensor system. The seeker ball may include a plurality of targets including variable pitch diffraction gratings disposed at different positions on a surface of the seeker ball relative to each other. Each HPGI sensor may include a corresponding stop radially aligned with a center of the seeker ball and configured to track a position of a corresponding target of the plurality of targets.

Any single one or any combination of the following features may be used with the above examples. The plurality of targets may include a first target including a first variable pitch diffraction grating at a first position on a surface of the seeker ball, a second target including a second variable pitch diffraction grating at a second position on the surface of the seeker ball orthogonal to the first position, and a third target including a third variable pitch diffraction grating at a third position on the surface of the seeker ball orthogonal to the first position and the second position. The plurality of cylindrically-symmetric HPGI sensors may include a first cylindrically-symmetric HPGI sensor including a first stop radially aligned with a center of the seeker ball and configured to track a position of the first target, the first stop including at least a first aperture portion, a second cylindrically-symmetric HPGI sensor including a second stop radially aligned with the center of the seeker ball and configured to track a position of the second target, the second stop including at least the first aperture portion, and a third cylindrically-symmetric HPGI sensor including a third stop radially aligned with the center of the seeker ball and configured to track a position of the third target, the third stop including at least the first aperture portion. The controller may be configured to determine an absolute three angular position of the seeker ball based on the outputs of the first, second and third HPGI sensors. The sensor system may include an ultrasonic positioning system configured to position the seeker ball. The ultrasonic positioning system may be controlled to position the seeker ball based on the determined instantaneous and absolute three angular position of the seeker ball. Each HPGI sensor may include a multi-spectral light source configured to illuminate a position on the respective grating of the respective target at a zero angle of incidence determined from a vector normal to the respective grating, where the respective grating is configured to diffract incident light from the light source to form a multi-spectral diffraction pattern in which an angular dispersion of the diffraction pattern varies with an absolute position of the incident light illuminating the surface of the respective grating. Each HPGI sensor may include a first reflective surface configured to reflect a narrow band of the diffraction pattern transmitted through an entrance of the respective aperture at a constant angle determined from the vector normal to the respective grating. Each HPGI sensor may include a second reflective surface configured to reflect the narrow band of the diffraction pattern received from the first reflective surface. Each HPGI sensor may include a third reflective surface configured to reflect the narrow band of the diffraction pattern received from the second reflective surface. Each HPGI sensor may include a first spectrally-responsive photodetector geometrically positioned to detect the narrow band of the diffraction pattern received from the third reflective surface. Each of the outputs may be based on the narrow band of the diffraction pattern received by the respective first spectrally-responsive photodetector. Each HPGI sensor may include a second spectrally-responsive photodetector geometrically positioned to detect the narrow band of the diffraction pattern from the second reflective surface. Each of the outputs may be based on the narrow band of the diffraction pattern received by the respective second spectrally-responsive photodetector. Each of the stops may include a second aperture portion. Each of the first aperture portions may be a radially constant aperture portion. Each of the second aperture portions may be a radially varying aperture portion. Each aperture may be a circular aperture. A (or the) positioning system may be controlled to position the seeker ball based on the determined instantaneous and absolute three angular position of the seeker ball.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates a half-cut view of an example cylindrically-symmetrical high precision gimbal indicator (HPGI) sensor in accordance with this disclosure;

FIGS. 2A, 2B, and 2C illustrate an example seeker ball in accordance with this disclosure;

FIG. 3 illustrates another example of a cylindrically-symmetrical HPGI sensor in accordance with this disclosure;

FIG. 4A-4C illustrate another example of a cylindrically-symmetrical HPGI sensor in accordance with this disclosure;

FIGS. 5A and 5B illustrate an example nose cone section and ball joint gimbal (BJG) seeker assembly in accordance with this disclosure; and

FIG. 6 illustrates an example method of operating a sensor system in accordance with this disclosure.

### DETAILED DESCRIPTION

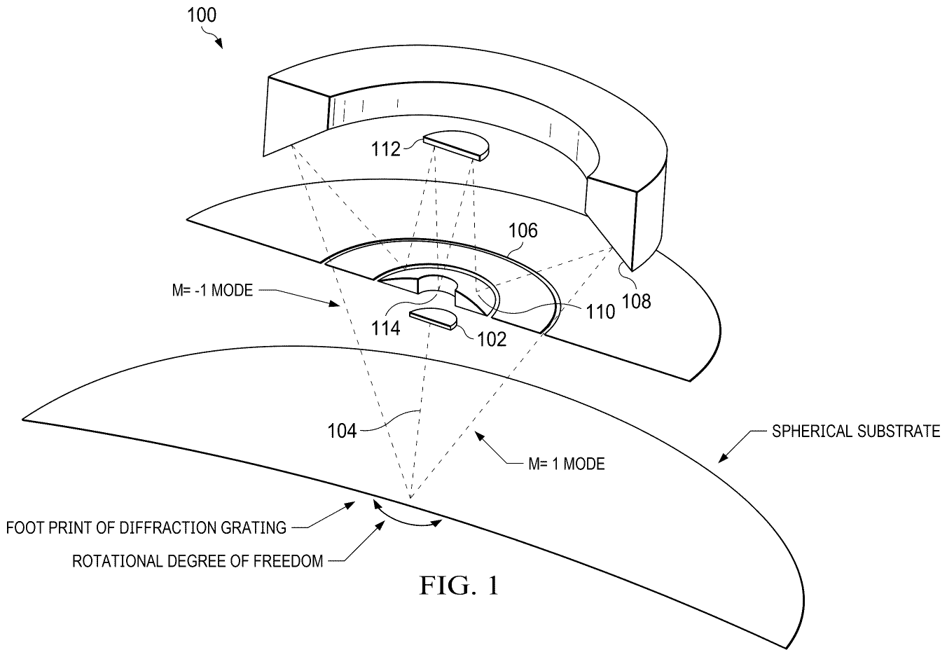

FIGS. 1 through 6, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, gimbaled system hardware for seekers and similar devices have been developed with an eye toward size and weight reductions for small-diameter airframes. This has led to a ball joint gimbal (BJG) design in which a seeker ball is controlled by a piezoelectric ultrasonic motor system. To properly control such a BJG, an absolute position encoder system may be used to track the angular position of the seeker ball. However, existing absolute position encoder systems are typically unable to properly track the angular orientation of a seeker ball when moving in three axes of angular rotation. This disclosure provides various high precision gimbal indicators (HPGIs) that can be used to, among other things, accurately track the angular orientation of a seeker ball when rotating in three orthogonal axes.

FIG. 1 illustrates a half-cut view of an example cylindrically-symmetrical HPGI sensor 100 in accordance with this disclosure. As can be seen in FIG. 1, the sensor 100 includes a multi-spectral light source 102. For example, the light source 102 may include one or more white light emitting diodes (LEDs), although the type of light and the number of light sources may vary. The light source 102 is configured to illuminate a position on a variable pitch diffraction grating on the surface of a seeker ball. During operation, the light source 102 illuminates the target at a zero angle of incidence determined from a vector normal to the grating. The grating diffracts incident light 104 from the light source 102 to form a multi-spectral diffraction pattern in which an angular dispersion of the diffraction pattern varies with an absolute position of the incident light illuminating the surface of the variable pitched grating. The angular dispersion may have various modes, such as modes M=1 and M=−1.

The sensor 100 also includes a stop 106 that includes a circular or other aperture, which is radially aligned with the center of the seeker ball. During operation, a narrow band of the diffraction pattern is transmitted through an entrance of the aperture of stop 106 at an angle determined from the vector normal to the grating. The narrow band of the diffraction pattern is reflected by a first reflective surface 108 onto a second reflective surface 110. The second reflective surface 110 reflects the narrow band of the diffraction pattern onto a third reflective surface 112, which reflects the narrow band of the diffraction pattern onto a spectrally-responsive photodetector 114. The spectrally-responsive photodetector 114 is geometrically positioned within sensor 100 to be illuminated by the narrow band of the diffraction pattern received from the third reflective surface 112. Output from the spectrally-responsive photodetector 114 may be utilized to determine a position of the target relative to the position of the sensor 100 based on a characterization of the diffraction grating of the target.

In some embodiments, the sensor 100 may be configured such that the spectrally-responsive photodetector 114 can receive multiple modes of the narrow band of the diffraction pattern. In other embodiments, however, the sensor 300 may be configured such that the spectrally-responsive photodetector 314 can receive a single mode of the narrow band of the diffraction pattern.

Although FIG. 1 illustrates a half-cut view of one example of a cylindrically-symmetrical HPGI sensor 100, various changes may be made to FIG. 1. For example, the HPGI sensor 100 could include additional spectrally-responsive photodetectors, a different shaped aperture, etc. according to particular needs.

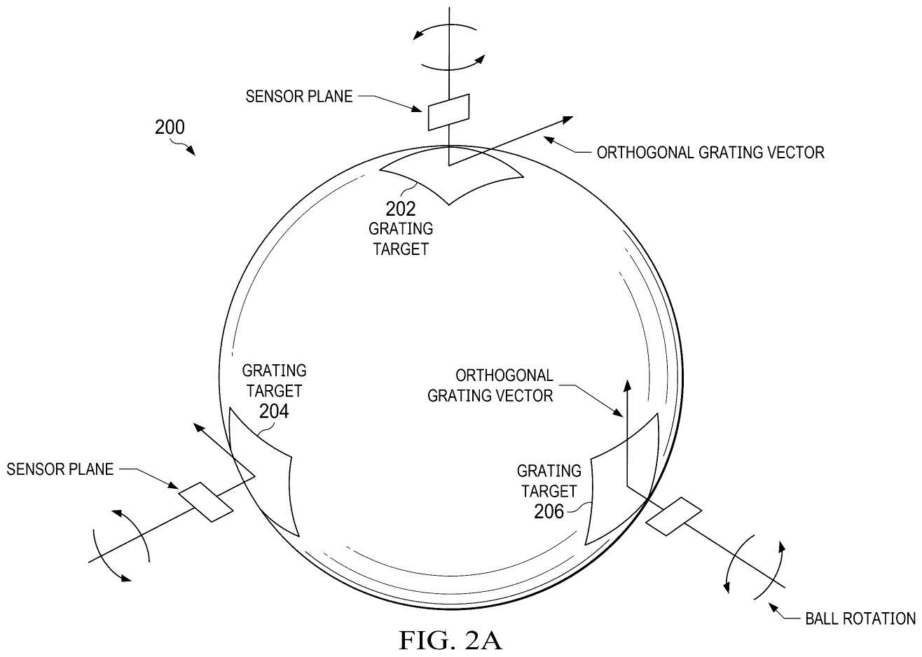

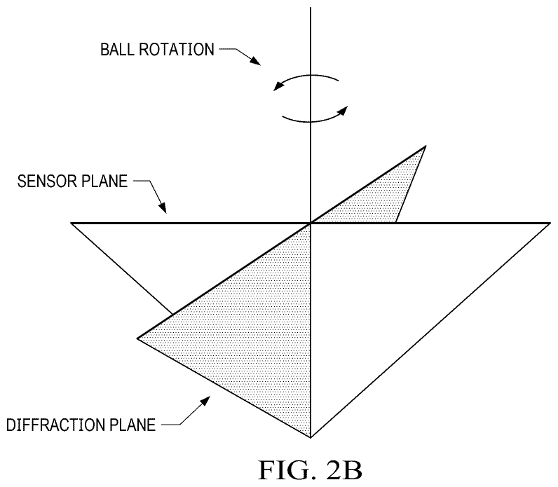

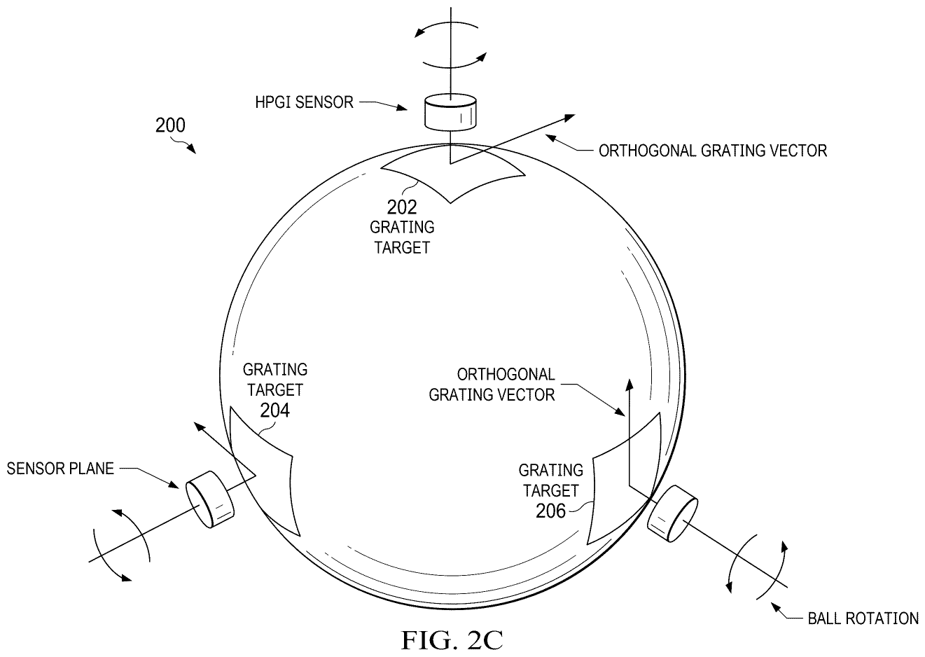

FIGS. 2A, 2B, and 2C illustrate an example seeker ball 200 in accordance with this disclosure. For ease of explanation, the seeker ball 200 shown in FIGS. 2A, 2B, and 2C is described as being used in conjunction with one or more instances of the HPGI sensor 100 shown in FIG. 1, such as when the seeker ball 200 is illuminated using one or more light sources 102. However, the seeker ball 200 may be used in any other suitable manner.

As shown in FIG. 2A, the seeker ball 200 includes a first target 202, a second target 204, and a third target 206 positioned on the surface of the seeker ball 200. Each target 202-206 includes a variable pitch diffraction grating. In the example here, the target 204 is positioned orthogonal to the target 202, and the target 206 is positioned orthogonal to the targets 202 and 204. In the example of FIGS. 2A through 2C, a diffraction pattern may be formed by the illumination of multispectral (such as white) light normal to the gratings on the targets 202-206, which span planes containing the positive/negative (M, −M) modes of diffracted light. Each sensor plane can be orthogonal to the surface of the variable pitched grating and parallel to the diffraction grating vector.

As shown in FIGS. 2A and 2B, as the seeker ball 200 moves in three axes relative to the three sensor planes, the diffraction patterns of the targets 202-206 are not constrained to be co-planar with their respective sensors. Thus, if a diffraction grating rotates (without translation), the diffraction pattern rotates with the grating vector and would leave the field of view of a stationary sensor. This prevents existing absolute position encoders from tracking the positions of the targets 202-206 when the seeker ball 200 rotates in tandem along two or more angular degrees of freedom afforded by all three axes.

To overcome this, the targets 202-206 may be tracked with a system of three cylindrically-symmetrical high precision gimbal indicator (HPGI) sensors, such as one shown in FIG. 1. By utilizing cylindrically-symmetrical HPGI sensors, rotation of the targets 202-206 with respect to the sensors does not affect the sensors' ability to track the targets 202-206 as diffracted rays passing through any segment of the circular aperture are always being reflected to the photodetector, regardless of the azimuthal orientation of the grating vector. Due to the cylindrical symmetry of the HPGI optical sensors 100, the signal for each sensor indicating one of the three angular states is decoupled from, and independent of, the angular states detected by any of the remaining sensors 100. This provides the ability to achieve closed-loop control over a ball joint gimbal, allowing for precision positioning, stabilization and slewing.

Although FIGS. 2A, 2B, and 2C illustrate one example of a seeker ball 200, various changes may be made to FIGS. 2A, 2B, and 2C. For example, while the seeker ball 200 is shown with three targets 202-206, the seeker ball 200 may include any suitable number of targets for tracking via any suitable number of sensors.

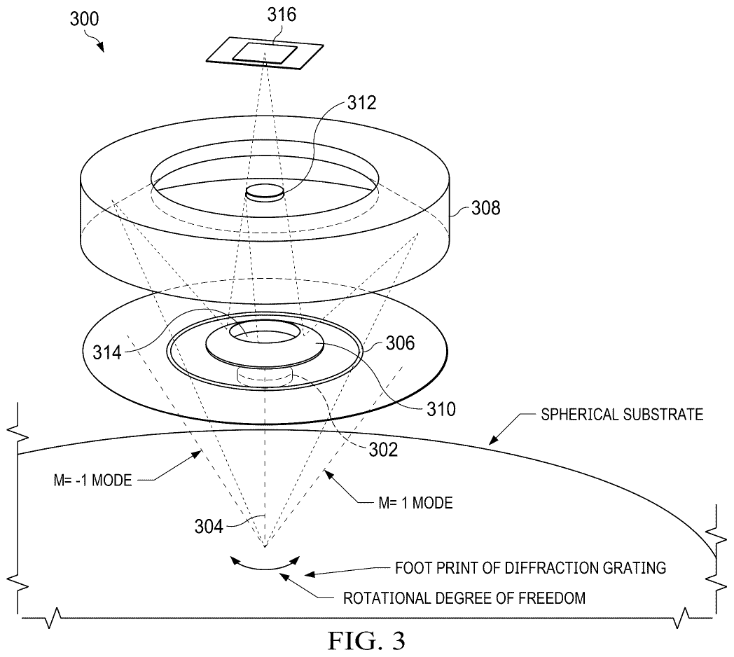

FIG. 3 illustrates another example of a cylindrically-symmetrical HPGI sensor 300 in accordance with this disclosure. As can be seen in FIG. 3, the sensor 300 includes a multi-spectral light source 302. For example, the light source 302 may include one or more white LEDs, although the type of light and the number of light sources may vary. The light source 302 is configured to illuminate a position on a variable pitch diffraction grating on the surface of a seeker ball (such as one of the targets 202-206 of the seeker ball 200). During operation, the light source 302 illuminates the target at a zero angle of incidence determined from a vector normal to the grating. The grating diffracts incident light 304 from the light source 302 to form a multi-spectral diffraction pattern in which an angular dispersion of the diffraction pattern varies with an absolute position of the incident light illuminating the surface of the variable pitched grating. The angular dispersion may have various modes, such as modes M=1 and M=−1 as shown in FIG. 3.

The sensor 300 also includes a stop 306 that includes a circular or other aperture, which is radially aligned with the center of the seeker ball. During operation, a narrow band of the diffraction pattern is transmitted through an entrance of the aperture of stop 306 at an angle determined from the vector normal to the grating. The narrow band of the diffraction pattern is reflected by a first reflective surface 308 onto a second reflective surface 310. The second reflective surface 310 reflects the narrow band of the diffraction pattern onto a first spectrally-responsive photodetector 316 and a third reflective surface 312. The spectrally-responsive photodetector 316 is geometrically positioned within sensor 300 to be illuminated by the narrow band of the diffraction pattern received from the second reflective surface 310. The third reflective surface 312 reflects the narrow band of the diffraction pattern onto a spectrally-responsive photodetector 314. The spectrally-responsive photodetector 314 is geometrically positioned within sensor 300 to be illuminated by the narrow band of the diffraction pattern received from the third reflective surface 312.

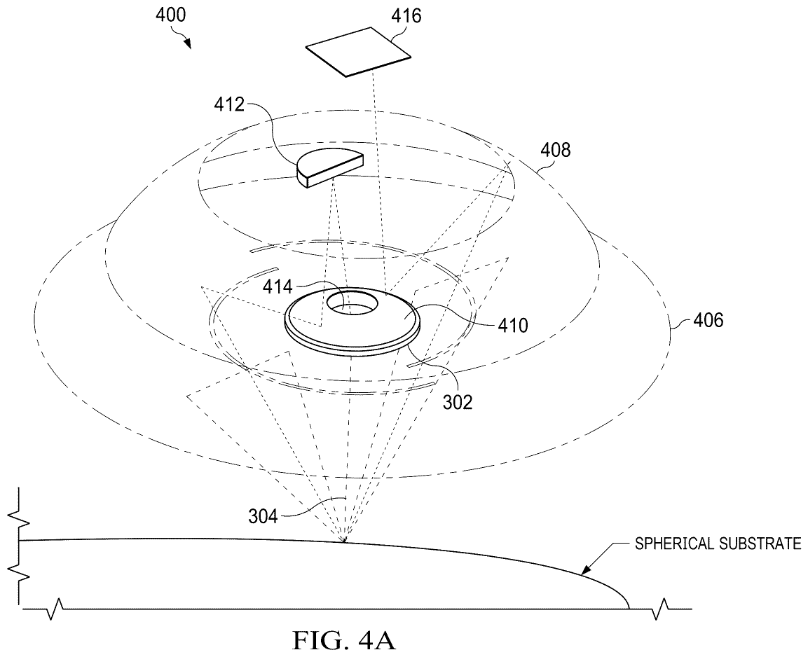

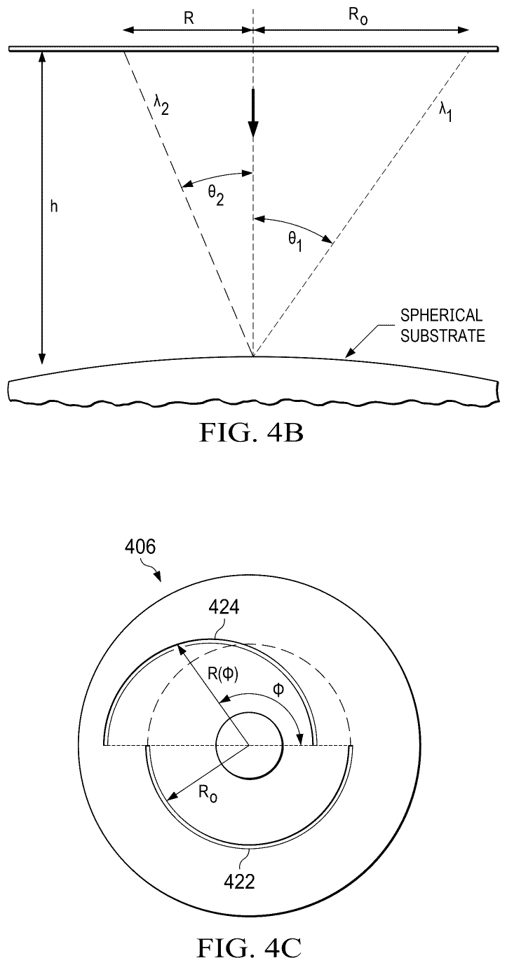

Outputs from the spectrally-responsive photodetectors 314 and 316 may be utilized to determine a position of the target relative to the position of the sensor 300 based on a characterizations of the diffraction gratings of the target. In some embodiments, the sensor 300 may be configured such that one or more of the spectrally-responsive photodetectors 314 and 316 can receive multiple modes of the narrow band of the diffraction pattern. For example, it can be seen in FIG. 4 that the spectrally-responsive photodetector 316 is receiving the modes M=1 and M=−1. In other embodiments, however, the sensor 300 may be configured such that one or more of the spectrally-responsive photodetectors 314 and 316 can receive a single mode of the narrow band of the diffraction pattern. For example, it can be seen in FIG. 3 that the spectrally-responsive photodetector 314 is only receiving the mode M=1.

Although FIG. 3 illustrates another example of a cylindrically-symmetrical HPGI sensor 300, various changes may be made to FIG. 3. For example, the HPGI sensor 300 could include additional spectrally-responsive photodetectors, a different shaped aperture, etc. according to particular needs.

FIGS. 4A-4C illustrate another example of a cylindrically-symmetrical HPGI sensor 400 in accordance with this disclosure. As can be seen in FIG. 4A, the sensor 400 includes a multi-spectral light source 402. For example, the light source 402 may include one or more white LEDs, although the type of light and the number of light sources may vary. The light source 402 is configured to illuminate a position on a variable pitch diffraction grating on the surface of a seeker ball (such as one of the targets 202-206 of the seeker ball 200). During operation, the light source 402 illuminates the target at a zero angle of incidence determined from a vector normal to the grating. The grating diffracts incident light 404 from the light source 402 to form a multi-spectral diffraction pattern in which an angular dispersion of the diffraction pattern varies with an absolute position of the incident light illuminating the surface of the variable pitched grating. The angular dispersion may have various modes, such as modes M=1 and M=−1.

The sensor 400 also includes a stop 406 that includes circular and a spiral aperture portions, which is radially aligned with the center of the seeker ball. During operation, a narrow band of the diffraction pattern is transmitted through an entrance of the aperture portions of stop 406 at an angle determined from the vector normal to the grating. The narrow band of the diffraction pattern is reflected by a first reflective surface 408 onto a second reflective surface 410. The second reflective surface 410 reflects the narrow band of the diffraction pattern onto a first spectrally-responsive photodetector 416 and a third reflective surface 412. The spectrally-responsive photodetector 416 is geometrically positioned within sensor 400 to be illuminated by the narrow band of the diffraction pattern received from the second reflective surface 410. The third reflective surface 412 reflects the narrow band of the diffraction pattern onto a spectrally-responsive photodetector 414. The spectrally-responsive photodetector 414 is geometrically positioned within sensor 400 to be illuminated by the narrow band of the diffraction pattern received from the third reflective surface 412.

As shown in FIG. 4C, it can be seen that the stop 406 includes aperture portions of different shapes, such as a circular portion 422 which has a constant radius and a spiral portion 424 which has a variable spiral radius. When a grating is rotated with respect to the stop 406, the narrow band of the diffraction pattern transmitted through the circular portion 422 remains the same, while the narrow band of the diffraction pattern transmitted through the spiral portion 424 changes in wavelength with the azimuthal rotation. In this manner, HPGI sensor 400 may independently track the position and the rotation of the target based on a characterization of the grating. For instance, spectrally-responsive photodetector 416 may be geometrically positioned within sensor 400 to be illuminated by the narrow band of the diffraction pattern transmitted through the spiral portion 404 to track the rotation of the target, while spectrally-responsive photodetector 414 may be geometrically positioned within sensor 400 to be illuminated by the narrow band of the diffraction pattern transmitted through the circular portion 402 to track the position of the target with respect to HPGI sensor 400, which allows for determination of a first and a second degree of angular positioning of the seeker ball.

FIG. 4B shows a side view of a diffraction pattern emerging from incident white light normal (solid arrow) to the ball at a height h above the surface. Two diffracted rays of +1 and −1 modes denote diffraction angles of θ₁ and θ₂ intersecting the aperture surface at radial positions Rₒ and R.

FIG. 4C shows a top view of the circular stop 406 with the two half segments containing the variable spiral radius aperture portion 424 and the constant radius aperture portion 422. The angle φ is the azimuthal rotation determined with the sensor parameters and the two diffracted rays reaching the two spectrally responsive detectors. The dotted semicircle on the top half is for refence to the semicircle aperture 422 on the lower half.

In the example of FIGS. 4A-4C, the position of the target with respect to HPGI sensor 400 may be determined as follows. The wavelength of light diffracted from a ruled grating of spacing d is a function of the angle of diffraction, when the angle if incidence is zero.

$$m λ = d sin θ$$

The modal degree of diffraction is m which can be any positive or negative integer. The following will assume m=|m|=1.

The radial distance of the from the center of the circular aperture 422 is Rₒ and R is the variable radius for the spiral aperture 424.

The relationship between a diffraction angle and the geometry of the sensor is,

$$sin θ = \frac{R}{\sqrt{{R}^{2} + {h}^{2}}} .$$

Taking the difference of the two wavelengths measured in the system give,

$$Δ {λ}_{1} = {λ}_{1} - {λ}_{2} = d ( sin {θ}_{1} - sin \text{?} {θ}_{2} ) \text{?} .$$

$$d = \frac{{λ}_{1}}{sin {θ}_{1}}$$

The grating spacing for each wavelength is simultaneous, so the term below can be substituted in the equation above.

$$Δ λ = d ( \frac{h}{\sqrt{{R}_{o}^{2} + {h}^{2}}} - \frac{h}{\sqrt{{R}^{2} + {h}^{2}}} ) = \frac{h {λ}_{1}}{sin {θ}_{1}} ( \frac{h}{\sqrt{{R}_{o}^{2} + {h}^{2}}} - \frac{h}{\sqrt{{R}^{2} + {h}^{2}}} )$$

Solving for the variable R yields an equation below.

$$R = h \sqrt{\frac{( {R}_{o}^{2} + {h}^{2} ) {λ}_{1}^{2}}{{( h λ - \sqrt{{R}_{o}^{2} + {h}^{2}} Δ λ sin {θ}_{1} )}^{2}} - 1}$$

A notional equation for the radial position of a spiral as a function of the azimuthal angle φ is,

$$R ( ϕ ) = {R}_{o} ( \frac{φ}{π} + \frac{1}{2} ) ,$$

with the constant scaling factor of Rₒ.

$$h \sqrt{\frac{( {R}_{o}^{2} + {h}^{2} ) {λ}_{1}^{2}}{{( h λ - \sqrt{{R}_{o}^{2} + {h}^{2}} Δ λ sin {θ}_{1} )}^{2}} - 1} = {R}_{o} ( \frac{φ}{π} + \frac{1}{2} )$$

Solving the above equation for the azimuthal angle φ gives, with measurable parameters of the sensor and the two detected wavelengths of diffracted rays.

Equating the solutions for R yields,

$$ϕ ( {λ}_{1} , {λ}_{2} ) = [ \frac{π h}{{R}_{o}} \sqrt{\frac{( {R}_{o}^{2} + {h}^{2} ) {λ}_{1}^{2}}{{( h λ - \sqrt{{R}_{o}^{2} + {h}^{2}} Δ λ sin {θ}_{1} )}^{2}} - 1} ] - \frac{π}{2} .$$

Although FIGS. 4A-4C illustrate another example of a cylindrically-symmetrical HPGI sensor 400, various changes may be made to FIGS. 4A-4C. For example, the HPGI sensor 400 could include additional spectrally-responsive photodetectors, a different shaped aperture, etc. according to particular needs.

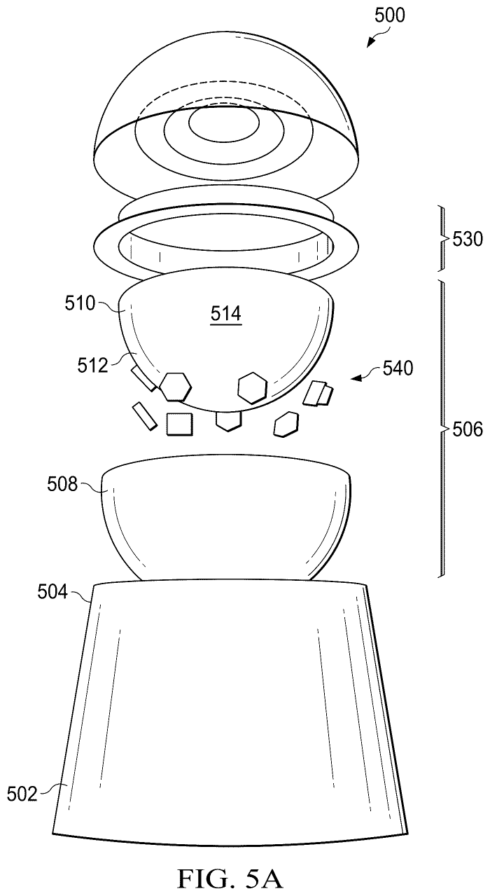

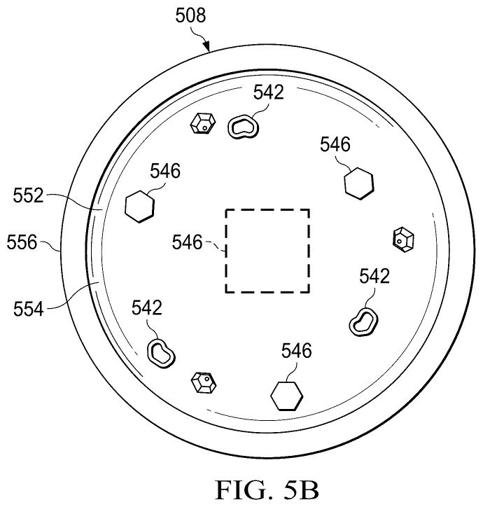

FIGS. 5A and 5B illustrate an example nose cone section and ball joint gimbal (BJG) seeker assembly 500, e.g., that can be used in a kinetic effector or munition, in accordance with this disclosure. More specifically, FIG. 5A illustrates an exploded perspective view of the assembly 500, and FIG. 5B illustrates a top-down view of a back shell and portions of a retaining system and a piezoelectric ultrasonic rotary motor and sensor system of the assembly 500.

As can be seen in FIGS. 5A and 5B, the assembly 500 includes a nose cone 502 and a BJG seeker assembly 506. The nose cone 502 has a frusto-conical or other shape that tapers inwardly with increasing distance in the forward direction and a rim 504 defining an open forward end. The BJG seeker assembly 506 includes a back shell 508, a seeker ball 510, a retaining system 530, and a control loop feedback angular sensor system 540. In this example, the seeker ball 510 has a body 512 with a convex surface 514. Seeker ball 510 may be identical or substantially similar to seeker ball 200 of FIG. 2. In some cases, the body 512 can have a spherical dome shape, which refers to a sphere that is cut by a plane at or above its equator. In this example, the back shell 508 has a partially semispherical body 552 with a concave surface 554 that terminates at a rim 556. The diameter of the rim 556 may be substantially similar to a diameter of the rim 504 of the nose cone 502 and may be coupled to the rim 504, such as by welding, interference fitting, mechanical fasteners, and/or adhesive.

In some cases, the piezoelectric ultrasonic motor and sensor system 540 may be pre-loaded by the retaining system 530 and can be configured to controllably drive an angular orientation of the seeker ball 510 relative to the back shell 508 based on a closed-loop control algorithm. For example, the piezoelectric ultrasonic motor and sensor system 540 may include three or more piezoelectric ultrasonic motors 542 and at least one seeker ball angular orientation sensor 544 mounted within back shell 508. The piezoelectric ultrasonic motor and sensor system 540 may also include a closed-loop controller 546, which may be disposed in signal communication with each of the three or more piezoelectric ultrasonic motors 542, the at least one seeker ball angular orientation sensor 544, and a control processor. The at least one seeker ball angular orientation sensor 544 may be identical or substantially similar to any of HPGI sensor 100 of FIG. 1, HPGI sensor 300 of FIG. 3 and/or HPGI sensor 400 of FIG. 4.

In some embodiments, the at least one seeker ball angular orientation sensor 544 may be an absolute position encoder that tracks the position of one or more targets mounted on seeker ball 510. For example, the targets may be identical or substantially similar to targets 202-206 of FIG. 2, and the at least one seeker ball angular orientation sensor 544 may be used to track a first variable pitch diffraction grating located at a position on a surface 514 of the seeker ball 510. As a particular example, the assembly 500 may include three sensors 544 and three targets, an example of which is shown in FIG. 2 described above.

Although FIGS. 5A and 5B illustrate one example of a nose cone section and BJG seeker assembly 500, various changes may be made to FIGS. 5A and 5B. For example, while the assembly 500 here is described as representing an assembly for that can be used in a kinetic effector or munition, the assembly 500 could be configured for other applications, such as lightweight camera pods for drones, other unmanned aerial vehicles (UAVs) including commercial UAVs, robotic devices, medical surgical equipment and/or or other flight vehicles.

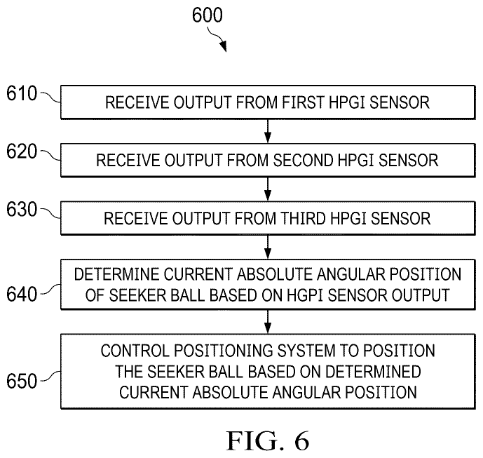

FIG. 6 illustrates an example method 600 of operating a sensor system in accordance with this disclosure. For ease of explanation, the method 600 shown in FIG. 6 may be described as involving the use of various components of FIGS. 1 through 5B. However, the method 600 shown in FIG. 6 may be involve the use of any suitable device(s) and in any suitable system(s).

As shown in FIG. 6, at step 610, a sensor system (such as the nose cone section and BJG seeker assembly 500) receives, from a first cylindrically-symmetric HPGI sensor (such as a first HPGI sensor 100), a first output. At step 620, the sensor system receives, from a second cylindrically-symmetric HPGI sensor (such as a second HPGI sensor 100), a second output. At step 630, the sensor system receives, from a third cylindrically-symmetric HPGI sensor (such as a third HPGI sensor 100), a third output. At step 640, the sensor system determines, based on the first output, the second output, and the third output, an instantaneous and absolute three angular position of a seeker ball (such as the seeker ball 200) of the sensor system.

The instantaneous and absolute three angular position of the seeker ball may be used in any suitable manner. For example, at step 650, the sensor system may control a positioning system (such as the piezoelectric ultrasonic motor and sensor system 540) to position the seeker ball based on the determined instantaneous and absolute three angular position of the seeker ball. As a particular example, the BIG system may adjust the position of the seeker ball due to a drift, or the BJG system may position the seeker ball to a different angular position relative to the instantaneous and absolute three angular position.

Although FIG. 6 illustrates one example of a method 600 of operating a sensor system, various changes may be made to FIG. 6. For example, while shown as a series of steps, various steps in FIG. 6 could overlap, occur in parallel, occur in a different order, or occur any number of times (including zero times).

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A sensor system comprising:
a seeker ball;
a plurality of targets including variable pitch diffraction gratings disposed at different positions on a surface of the seeker ball relative to each other;
a plurality of cylindrically-symmetric high precision gimbal indicator (HPGI) sensors, each HPGI sensor including a corresponding stop radially aligned with a center of the seeker ball and configured to track a position of a corresponding target of the plurality of targets; and
a controller configured to receive outputs from the HPGI sensors and determine, based on the outputs, an instantaneous and absolute angular position of the seeker ball.

2. The sensor system of claim 1, wherein the plurality of targets comprise:
a first target including a first variable pitch diffraction grating at a first position on a surface of the seeker ball;
a second target including a second variable pitch diffraction grating at a second position on the surface of the seeker ball orthogonal to the first position; and
a third target including a third variable pitch diffraction grating at a third position on the surface of the seeker ball orthogonal to the first position and the second position.

3. The sensor system of claim 2, wherein the plurality of cylindrically-symmetric HPGI sensors comprise:
a first cylindrically-symmetric HPGI sensor including a first stop radially aligned with a center of the seeker ball and configured to track a position of the first target, the first stop including at least a first aperture portion;
a second cylindrically-symmetric HPGI sensor including a second stop radially aligned with the center of the seeker ball and configured to track a position of the second target, the second stop including at least the first aperture portion; and
a third cylindrically-symmetric HPGI sensor including a third stop radially aligned with the center of the seeker ball and configured to track a position of the third target, the third stop including at least the first aperture portion; and
wherein the controller is configured to determine an absolute three angular position of the seeker ball based on the outputs of the first, second and third HPGI sensors.

4. The sensor system of claim 3, wherein:
each of the stops includes a second aperture portion,
each of the first aperture portions is a radially constant aperture portion; and
each of the second aperture portions is a radially varying aperture portion.

5. The sensor system of claim 1, wherein:
the sensor system further includes an ultrasonic positioning system configured to position the seeker ball; and
the controller is further configured to control the ultrasonic positioning system to position the seeker ball based on the determined instantaneous and absolute angular position of the seeker ball.

6. The sensor system of claim 1, wherein each of the HPGI sensors comprises:
a multi-spectral light source configured to illuminate a position on the respective grating of the respective target at a zero angle of incidence determined from a vector normal to the respective grating, wherein the respective grating is configured to diffract incident light from the light source to form a multi-spectral diffraction pattern in which an angular dispersion of the diffraction pattern varies with an absolute position of the incident light illuminating the surface of the respective grating;
a first reflective surface configured to reflect a narrow band of the diffraction pattern transmitted through an entrance of a respective aperture at an angle determined from the vector normal to the respective grating;
a second reflective surface configured to reflect the narrow band of the diffraction pattern received from the first reflective surface;
a third reflective surface configured to reflect the narrow band of the diffraction pattern received from the second reflective surface; and
a first spectrally-responsive photodetector geometrically positioned to detect the narrow band of the diffraction pattern received from the third reflective surface.

7. The sensor system of claim 6, wherein each of the outputs is based on the narrow band of the diffraction pattern received by the respective first spectrally-responsive photodetector.

8. The sensor system of claim 7, wherein each of the HPGI sensors further comprises a second spectrally-responsive photodetector geometrically positioned to detect the narrow band of the diffraction pattern from the second reflective surface.

9. The sensor system of claim 8, wherein each of the outputs is further based on the narrow band of the diffraction pattern received by the respective second spectrally-responsive photodetector.

10. A method of operating a sensor system, the method comprising:
receiving outputs from a plurality of cylindrically-symmetric high precision gimbal indicator (HPGI) sensors; and
determining, based on the outputs, an instantaneous and absolute angular position of a seeker ball of the sensor system;
wherein:
the seeker ball includes a plurality of targets including variable pitch diffraction gratings disposed at different positions on a surface of the seeker ball relative to each other; and
each HPGI sensor includes a corresponding stop radially aligned with a center of the seeker ball and configured to track a position of a corresponding target of the plurality of targets.

11. The method of claim 10, wherein the plurality of targets comprise:
a first target including a first variable pitch diffraction grating at a first position on a surface of the seeker ball;
a second target including a second variable pitch diffraction grating at a second position on the surface of the seeker ball orthogonal to the first position; and
a third target including a third variable pitch diffraction grating at a third position on the surface of the seeker ball orthogonal to the first position and the second position.

12. The method of claim 11, wherein the plurality of cylindrically-symmetric HPGI sensors comprise:
a first cylindrically-symmetric HPGI sensor including a first stop radially aligned with a center of the seeker ball and configured to track a position of the first target, the first stop including at least a first aperture portion;
a second cylindrically-symmetric HPGI sensor including a second stop radially aligned with the center of the seeker ball and configured to track a position of the second target, the second stop including at least the first aperture portion; and
a third cylindrically-symmetric HPGI sensor including a third stop radially aligned with the center of the seeker ball and configured to track a position of the third target, the third stop including at least the first aperture portion; and
wherein the method further comprises determining an absolute three angular position of the seeker ball based on the outputs of the first, second and third HPGI sensors.

13. The method of claim 10, further comprising:
controlling a positioning system to position the seeker ball based on the determined instantaneous and absolute angular position of the seeker ball.

14. The method of claim 10, wherein each of the HPGI sensors comprises:
a multi-spectral light source configured to illuminate a position on the respective grating of the respective target at a zero angle of incidence determined from a vector normal to the respective grating, wherein the respective grating is configured to diffract incident light from the light source to form a multi-spectral diffraction pattern in which an angular dispersion of the diffraction pattern varies with an absolute position of the incident light illuminating the surface of the respective grating;
a first reflective surface configured to reflect a narrow band of the diffraction pattern transmitted through an entrance of a respective aperture at an angle determined from the vector normal to the respective grating;
a second reflective surface configured to reflect the narrow band of the diffraction pattern received from the first reflective surface;
a third reflective surface configured to reflect the narrow band of the diffraction pattern received from the second reflective surface; and
a first spectrally-responsive photodetector geometrically positioned to detect the narrow band of the diffraction pattern received from the third reflective surface.

15. The method of claim 14, wherein each of the outputs is based on the narrow band of the diffraction pattern received by the respective first spectrally-responsive photodetector.

16. The method of claim 15, wherein each of the HPGI sensors further comprises a second spectrally-responsive photodetector geometrically positioned to detect the narrow band of the diffraction pattern from the second reflective surface.

17. The method of claim 16, wherein each of the outputs is further based on the narrow band of the diffraction pattern received by the respective second spectrally-responsive photodetector.

18. A non-transitory machine readable medium containing instructions that, when executed by at least one processor, cause the at least one processor to:
receive outputs from a plurality of cylindrically-symmetric high precision gimbal indicator (HPGI) sensors; and
determine, based on the outputs, an instantaneous and absolute angular position of a seeker ball of a sensor system;
wherein:
the seeker ball includes a plurality of targets including variable pitch diffraction gratings disposed at different positions on a surface of the seeker ball relative to each other; and
each HPGI sensor includes a corresponding stop radially aligned with a center of the seeker ball and configured to track a position of a corresponding target of the plurality of targets.

19. The non-transitory machine readable medium of claim 18, wherein the plurality of targets comprise:
a first target including a first variable pitch diffraction grating at a first position on a surface of the seeker ball;
a second target including a second variable pitch diffraction grating at a second position on the surface of the seeker ball orthogonal to the first position; and
a third target including a third variable pitch diffraction grating at a third position on the surface of the seeker ball orthogonal to the first position and the second position.

20. The non-transitory machine readable medium of claim 19, wherein the plurality of cylindrically-symmetric HPGI sensors comprise:
a first cylindrically-symmetric HPGI sensor including a first stop radially aligned with a center of the seeker ball and configured to track a position of the first target, the first stop including at least a first aperture portion;
a second cylindrically-symmetric HPGI sensor including a second stop radially aligned with the center of the seeker ball and configured to track a position of the second target, the second stop including at least the first aperture portion; and
a third cylindrically-symmetric HPGI sensor including a third stop radially aligned with the center of the seeker ball and configured to track a position of the third target, the third stop including at least the first aperture portion; and
wherein the instructions cause the at least one processor to determine an absolute three angular position of the seeker ball based on the outputs of the first, second and third HPGI sensors.
